(19) United States
(12) Patent Application Publication
(10) Pub. No.: US 2008/0144935 A1
(43) Pub. Date: Jun. 19, 2008

(54) METHOD FOR SEGMENTATION OF DIGITAL IMAGES

(76) Inventors: Ramnada CHAV, Laval (CA); Ovalong Troeung, Sarrebourg (FR); Jacques A. DE Guise, Montreal (CA); Gilles Soulez, Outremont (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/948,247

(22) Filed: Nov. 30, 2007

Related U.S. Application Data
(60) Provisional application No. 60/867,941, filed on Nov. 30, 2006.
(60) Provisional application No. 60/912,040, filed on Apr. 16, 2007.

(51) Int. Cl. G06K 9/34

(52) U.S. Cl. 382/173

(57) ABSTRACT

A method for segmenting elements on an image, comprising: i) creating an active contour from at least one identified point on the image; ii) defining a reference intensity value from the pixels of the active contour; iii) simplifying the image by comparing the pixels of the image to the reference intensity value to give a propagation value to the pixels of the image; and iv) propagating the active contour in a selected one of an expansion/contraction direction as a function of the propagation value of the pixels adjacent to the active contour in the image; wherein ii), iii) and iv) are repeated in the selected direction whereby the active contour finally represents the element segmented in the image.

### CROSS-REFERENCE TO RELATED APPLICATIONS

This patent application claims priority on U.S. Provisional Patent Applications No. 60/867,941, filed Nov. 30, 2006, and No. 60/912,040, filed Apr. 16, 2007.

### FIELD OF THE APPLICATION

The present application relates to digital imaging and, more particularly, to a method for performing segmentation in 2D or 3D digital images.

### BACKGROUND OF THE INVENTION

One of the most important problems in segmentation is related to the difficulty in perceiving frontier or boundary (blurry, as in FIG. 1a, noisy, as in FIG. 1b, or partially missing, as in FIG. 1c) of the structure to segment. These problems generally cause “leakage” of the active contour when using classical algorithms like the Region Growing method.

Active contours are deformable shapes that can move under the action of forces called speed term. The evolution of an active contour generally allows bidirectional propagation (toward the inside or the outside).

Some methods, like the deformable model known as “Snake” (Kass, M., Witkin, A., Terzololous, D., “Snakes: Active Contour Models,” International Journal of Computer Vision, 1(4), 321-331, 1987), rely on the movement of markers represented by connected points, moving together according to the speed term F in the direction of the normal to the contour as represented in FIG. 2a. The precision of the segmentation increases when the number of markers increases. Problems occur when markers cross over others as in FIG. 2b, or when part of the active contour tries to merge or split as in FIG. 2c.

To overcome this kind of problem, the Level Set method by Osher et al. is commonly used (Osher, S., Sethian, J. A., “Fronts propagating with curvature dependent speed: algorithms based on the Hamilton-Jacobi formalism,” J. Computational Physics, 79:12{43, 1988) as shown in FIG. 3. The Level Set method is a particular implementation of the methods based on the active contours. This approach is used in many types of applications such as simulation of physical phenomena, denoising, registration and segmentation.

This method is based on an implicit representation of an active contour generally initialised by the end user. Instead of following the evolution of the active contour, the evolution of a signed distance function is followed, which function includes the active contour generally represented by the zero of that function as shown in FIG. 3. The signed distance function is expressed by the distance of a point to the closest point of the active contour. The interior/exterior of the active contour is determined by its sign (negative/positive). The evolution of the active contour is possible by resolving a partial derivative equation (PDE). One of the parameters upon which the PDE is based is named the Speed function, and indicates how the active contour has to move. Solving the PBS is time-consuming even if many optimisation methods exist, whereby the Level Set is a slow segmentation method.

Recently, Shi et al. (Shi, Y., Karl, W. C., “A fast implementation of the level set method without solving partial differential equations,” Technical Report ECE-2005-02, ECE Department, Boston University, January 2005) have proposed a new technique for the segmentation of images. It maintains some features of the Level Set method, such as the topology flexibility (split and merge) of the active contour during its evolution, and facilitates the adaptation of the model to superior dimensions without having to solve the PDE, unlike in the Level Set method. To make it possible, the segmentation is done by management of points lists that permit knowing exactly the position of the active contour for a given iteration.

The method set forth by Shi et al. involves two steps. The first step consists in evolving the active contour forward or backward by one pixel per iteration by transferring a point from one list to the other. The second step consists in controlling the curvature of the active contour by a Gaussian filter applied on the active contour. The second step is used when the active contour is too sensitive to the noise, and to keep the active contour smooth. Like the step of evolution, the curvature control step cannot move the active contour more than one pixel per iteration because it is limited by the list management of the active contour. Moreover, when the goal of the algorithm is to prevent leakage, a filter of big size is necessary and numerous iterations of curvature control are needed.

### SUMMARY OF INVENTION

It is therefore a feature of the present application to provide a segmentation method that addresses issues associated with the prior art.

According to the above features of the present application, there is provided a method for segmenting elements on an image, comprising: i) creating an active contour from at least one identified point on the image; ii) defining a reference intensity value from the pixels of the active contour; iii) simplifying the image by comparing the pixels of the image to the reference intensity value to give a propagation value to the pixels of the image; and iv) propagating the active contour in a selected one of an expansion/contraction direction as a function of the propagation value of the pixels adjacent to the active contour in the image; wherein ii), iii) and iv) are repeated in the selected direction whereby the active contour finally represents the element segmented in the image.

Further in accordance with the present application, there is provided a method for segmenting elements on an image, comprising: i) creating an active contour from at least one identified point on the image, points of the active contour having a binary value; ii) defining a reference intensity value from the pixels of the active contour; iii) comparing the pixels of the image to the reference intensity value to give a propagation value to the pixels of the image; and iv) propagating the active contour in a selected one of an expansion/contraction direction as a function of the propagation value of the pixels adjacent to the active contour in the image, whereby points of the propagating active contour has a binary value; wherein ii), iii) and iv) are repeated in the selected direction whereby the active contour finally represents the element segmented in the image.

### BRIEF DESCRIPTION OF THE DRAWINGS

FIG. 1a is an image illustrating a blurry boundary;

FIG. 1b is an image illustrating a noisy boundary;

FIG. 1c is an image illustrating partially missing boundaries;

FIG. 2a is an image of a propagation of a “snake” deformable model;

FIG. 2b is an image of a crossover in the propagation of the “snake” deformable model;

FIG. 2c is an image of merging “snake” deformable models;

FIG. 3 is a schematic illustration of a propagation in the Level Set method;

FIG. 4 is a method for segmentation of digital images in accordance with an embodiment of the present application;

FIGS. 5a to 5c are respectively blurry, noisy and missing-boundary images being segmented using the method of the present application; and

FIGS. 6a and 6b are respectively brain and aorta images sequentially during a segmentation with the method of the present application.

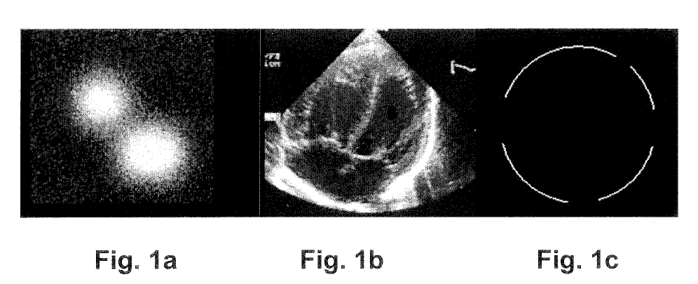

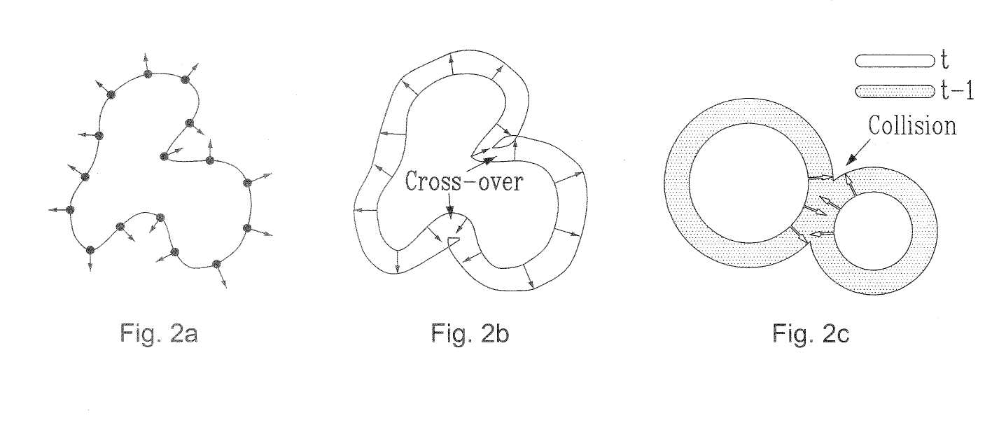

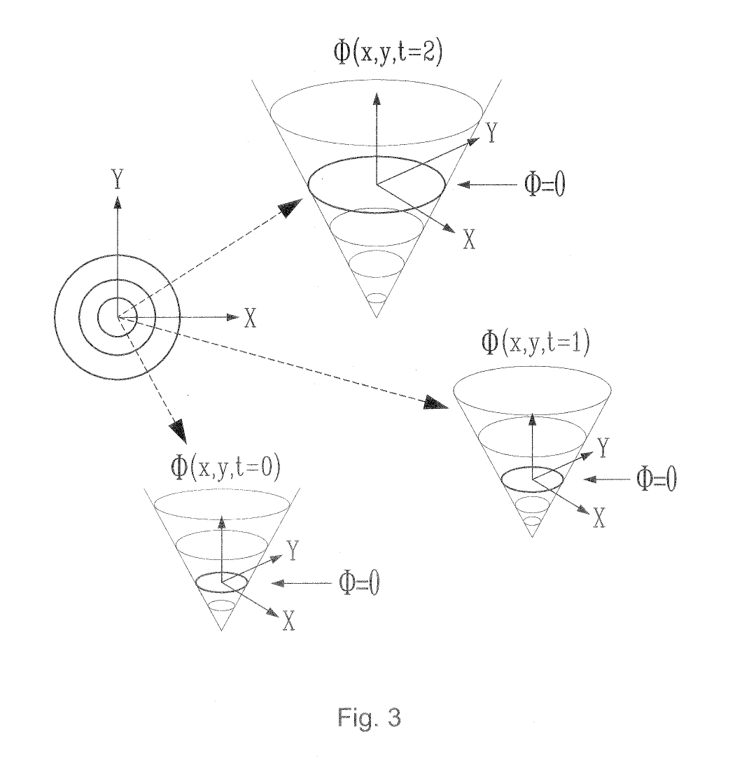

### DESCRIPTION OF THE PREFERRED EMBODIMENTS

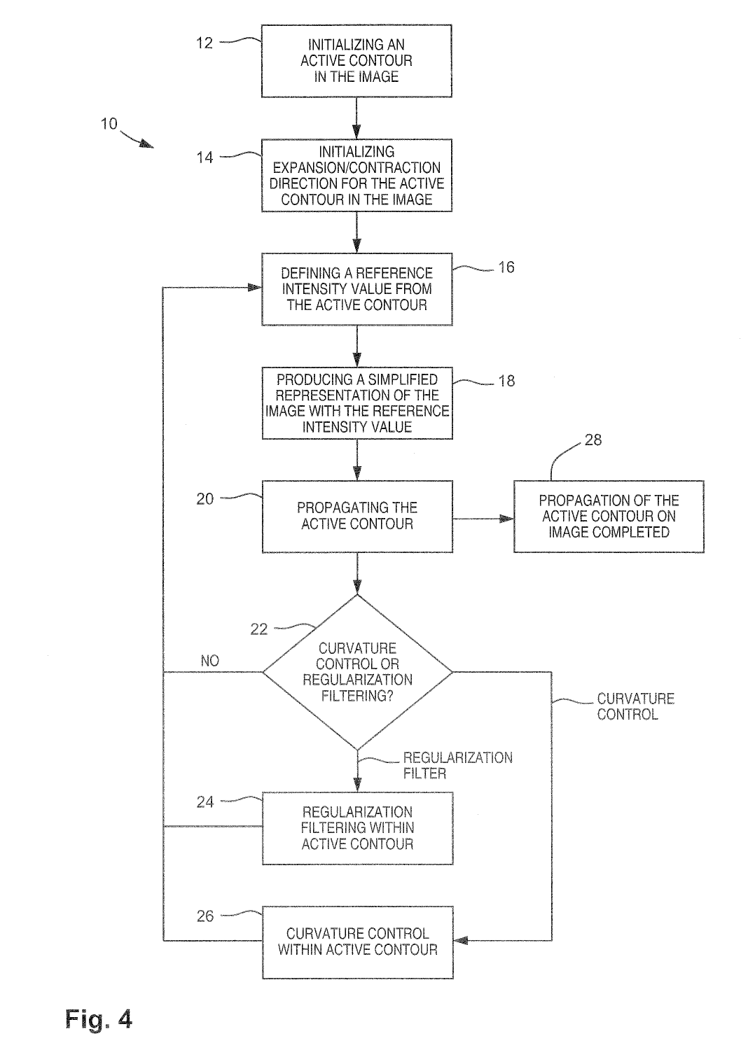

Referring to FIG. 4, a method for the segmentation of digital images in accordance with an embodiment is generally illustrated at 10.

According to step 12, an active contour is initialized on the image. According to one embodiment, the active contour is initialized by a user identifying some markers on the image, which markers are related to an element or structure to be segmented. It is preferred that the markers be defined in proximity to the boundary of an element to be segmented. The markers may be outside of the element or inside of the element. According to a preferred embodiment, the active contour initialized in step 12 has a binary value.

It is also considered to automatically set the markers. As an example, in an industrial inspection application, the image represents a piece pictured by inspection cameras, and the marker is automatically set in the center of the image as the piece is typically centered in the image.

According to step 14, a direction for the active contour is initialized in the image. Therefore, according to the initialization of the active contour in step 12, a direction is given to the active contour for the subsequent propagation of the active contour. If the markers have been provided outside the element to segment, the direction given to the active contour will be a contraction direction, and vice versa. It is pointed out that the direction is preferably identified by a binary value. In the event that the active contour is automatically set, the direction may be a default direction (e.g., expansion).

In step 16, a reference intensity value is defined for the pixels within the propagating active contour. More specifically, statistical data for the pixels delimited by the active contour is calculated to define the reference intensity value. Numerous calculations can be performed to establish the reference intensity value.

As an example, an average intensity or median intensity is established with the pixels, so as to subsequently define thresholds with the average or median intensity and a standard deviation. Alternatively, other calculations or criteria such as intensity interpolation and texture analysis may be used as well.

According to step 18, a simplified representation of the image is produce using the reference intensity value so as to obtain a simplified image consisting of a propagation value for each pixel. According to a preferred embodiment, the propagation value is a binary value determining whether the boundary of the active contour is to be pulled or pushed. The simplified representation of the image is commonly known as a speed term image, and will be used by the active contour during propagation.

According to step 20, the active contour propagates using the simplified representation of the image (i.e., the speed term image). The use of a simplified image for the propagation simplifies the computation time required during propagation, thereby accelerating the segmentation of the digital image.

Steps 16, 18 and 20 represent an iteration allowing the incremental propagation of the active contour. In an embodiment, the incremental propagation, is performed for several pixels at a time, typically in areas of uniform intensity on the speed image. The incremental propagation is preferably one pixel level at a time near the boundary of elements. As the active contour propagates, the reference intensity value changes as additional pixels are captured in the propagating active contour. This will result in an increased accuracy in the propagation of the active contour in step 20.

The iteration by steps 16, 18 and 20 is cycled repeatedly, with intervening steps to filter the pixels of the active contour to remove noise and to control the curvature of the active contour to avoid leakage. More specifically, after a given number of iterations have been performed, the step 24 of regularization filtering, or the step 26 of curvature control, is performed, as set forth in decision 22.

According to step 24, the regularization filtering within the active contour involves a filter that compares concurrently a plurality of pixels within a predetermined filter size. The regularization filtering allows the conversion of pixels to a corrected intensity value for the pixel. The step of regularization filtering 24 is used to remove noise and other abnormalities from the elements being segmented. For instance, a Gaussian filter is used but other types of filters are considered as well.

Once the regularization filtering is completed, the reference intensity value redefined in step 16 will take into account the regularization filtering. This will result in an increased accuracy in the propagation of the active contour in step 20.

According to step 26, the curvature is controlled for the active contour. In step 26, a filter of a predetermined size filters the boundary curvatures of the active contour. The filter size in the curvature control is typically greater than the filter used in the regularization filtering. The boundary of the active contour is typically smoothened when leakage would otherwise occur. Optionally, the user may modify the filter size in the curvature control filtering in order to manually select a segmented image in which the segmented element matches an expected shape.

It is pointed out that the curvature control filtering also optionally performs a regularization filtering of noise within elements segmented by the propagating active contour. A similar filter is used in steps 24 and 26, but with the filter used in step 26 typically greater in dimension as leakage between neighboring structures usually involves a greater amount of pixels.

Once the curvature control is completed, the reference intensity value redefined in step 16 will take into account the curvature filtering. This will result in an increased accuracy in the propagation of the active contour in step 20.

Once the active contour has propagated through the image, the segmentation is completed, as set forth in step 28.

The proposed method offers many advantages in relation to existing methods. Firstly, the method of the present application avoids a major problem found in Level Set method, that is, computing time to solve PDE equations to assure the propagation of the active contour. Moreover, the method of the present application does not involve list management, as is the case with the method of Shi et al. The use of lists to follow the evolution of the active contour limits the propagation to only one pixel per iteration. Also, using the Shi et al. method, considerable size of smoothing filter has to be used iteratively to avoid leaks of the active contour in neighbouring structures.

With the method of the present application, implicit representation is used. Only one iteration of smoothing is needed to control the curvature of the active contour, irrespective of the size of the smoothing filter.

Depending on the filtering step (i.e., step 24 or 26), the size of the filter can vary. To avoid sensibility of the active contour to the noise, a small size approximately 3 to 5 pixels can be used. When used to smooth the active contour, the size of the filter is dependent on the size of the active contour. To prevent leaks in a neighbouring region, a size equivalent to the diameter of the leak can generally be used.

A first optimisation for the present method is to use a dynamic bounding box that contains the active contour, with the outside being an inactive zone. During the evolution of the active contour, this bounding box is automatically modified to always contain the active contour inside the bounding box. Reducing the region to a region of interest reduces considerably the number of operations.

A second possible optimisation has been done to significantly reduce the computation time. During the propagation of the active contour, some parts can reach their final state before others. Calculations on these regions of the active contour are then not necessary when they reach their final position for the segmentation. Therefore, according to this option, the propagation is locally stopped when the element has been locally segmented. Therefore, considering this can accelerate the speed of segmentation as the active contour approaches the final segmentation.

Such an approach is similar to the one proposed by Deschamps (Deschamps, T., “Curve and Shape Extraction with Minimal Paths and Level-Sets Techniques. Applications to 3D Medical Imaging,” Ph.D. thesis, Université Paris-IX, Dauphine, 2001) for the segmentation of the aorta.

This second optional optimisation relies on the characteristic proposed in multi-resolution to reduce the computation time. First, the image is subdivided into zones such that each zone contains a determined number of pixels. Pixels that were on the border of the active contour will be called active pixels. Therefore, zones containing active pixels are activated. Only active zones will be used in the next iteration.

In another representation of the method 10, the steps involve:

The initialization of the binary implicit active contour Phi (φ): one inside, zero outside.

The creation of the speed term (g) to provide a propagation direction: one to push, zero to pull the active contour.

The creation of the zone image(f), the simplified representation: one for active zone, zero for inactive zones.

The evolution (propagation) of the active contour for active zones.

The expansion of the active contour: φ=E(φ)×g; or

The contraction of the active contour: φ=C(φ)× g̅;

The simplified representation f is updated: for each zone, if the active contour did not move, the zone (set the zone is frozen to −1).

The curvature control step for the active contour for the active zone.

The curvature control by a smoothing function.

If the stopping criterion is not reached: return to Step 2.

Else: end of the algorithm.

It is considered to use the method 10 in different applications, medical imaging, industrial inspection surveillance, amongst other numerous possibilities. Moreover, it is considered to use the method 10 for 2D and 3D images, as well as for segmenting elements in videos. In such a case, it is suggested to use the segmented image as the initial active contour in segmenting the following image in the video. Accordingly, the computing time is reduced by such a step.

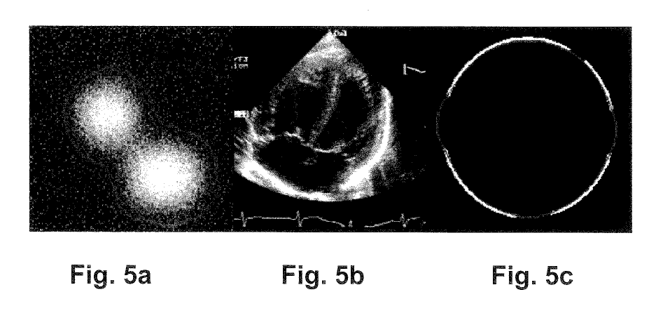

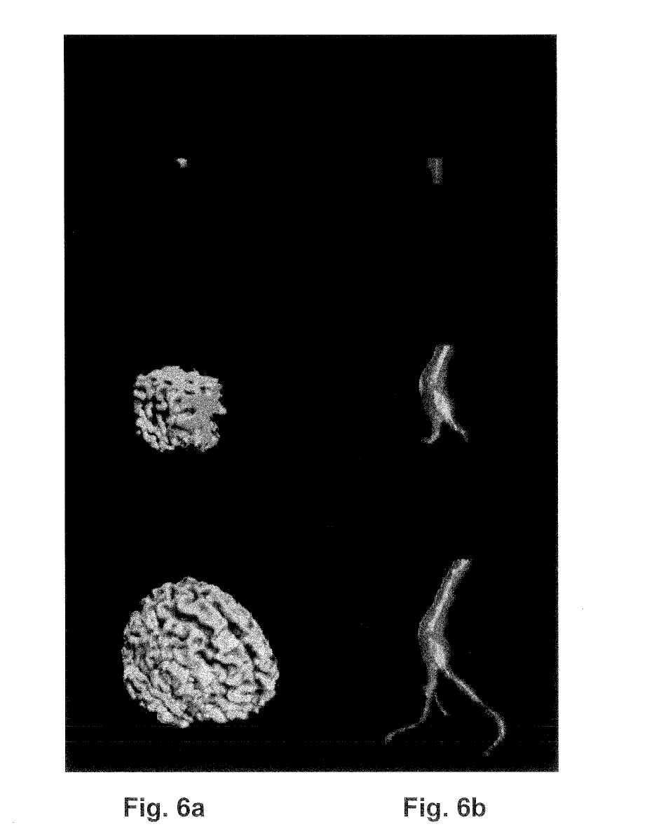

As an example, various images are provided to illustrate the segmentation of images with the method 10. FIGS. 5a to 5c are respectively blurry, noisy and missing-boundary images being segmented using the method 10. In order to provide am example of a segmented image resulting from the method 10, FIGS. 6a and 6b are provided, and respectively represent brain and aorta images sequentially during a segmentation with the method of the present application.

1. A method for segmenting elements on an image, comprising:
i) creating an active contour from at least one identified point on the image;
ii) defining a reference intensity value from the pixels of the active contour;
iii; simplifying the image by comparing the pixels of the image to the reference intensity value to give a propagation value to the pixels of the image; and
iv) propagating the active contour in a selected one of an expansion/contraction direction as a function of the propagation value of the pixels adjacent to the active contour in the image;
wherein ii), iii) and iv) are repeated in the selected direction whereby the active contour finally represents the element segmented in the image.

2. The method according to claim 1, wherein i) creating the active contour comprises obtaining manually entered markers and the expansion/contraction direction.

3. The method according to claim 1, wherein ii) defining the reference intensity value comprises establishing a threshold value for comparing pixels.

4. The method according to claim 3, wherein establishing the threshold value comprises calculating statistical data for given pixels within the propagating active contour as a function of the expansion/contraction direction.

5. The method according to claim 3, wherein iii) simplifying the image comprises giving a binary value as the propagation value as a function of the threshold value.

6. The method according to claim 1, wherein iii) simplifying the image comprises giving a binary value as the propagation value.

7. The method according to claim 1, further comprising filtering pixels within the propagating active contour to regularize the pixel intensity of elements within the propagating active contour.

8. The method according to claim 7, wherein said filtering pixels is performed periodically between a plurality of sequences of ii), iii) and iv).

9. The method according to claim 1, further comprising filtering pixels within the propagating active contour to regularize a boundary curvature of elements.

10. The method according to claim 9, wherein said controlling is performed periodically between a plurality of sequences of ii), iii) and iv).

11. The method according to claim 1, wherein i) creating the active contour comprises automatically setting markers and a default expansion/contraction direction.

12. The method according to claim 4, wherein establishing the threshold value comprises calculating an average intensity and a standard deviation as statistical data.

13. The method according to claim 1, wherein i) creating the active contour and iv) propagating the active contour comprises giving a binary value to pixels of the propagating active contour.

14. The method according to claim 1, wherein i) creating the active contour comprises obtaining a previously segmented image with the active contour being segmented elements from the segmented image, in segmenting video images.

15. The method according to claim 1, further comprising obtaining an inactive zone for the image, and excluding the propagating from the inactive zone.

16. The method according to claim 1, further comprising stopping the propagating of the active contour locally when an element has been locally segmented.

17. A method for segmenting elements on an image, comprising:
i) creating an active contour from at least one identified point on the image, points of the active contour having a binary value;
ii) defining a reference intensity value from the pixels of the active contour;
iii) comparing the pixels of the image to the reference intensity value to give a propagation value to the pixels of the image; and
iv) propagating the active contour in a selected one of an expansion/contraction direction as a function of the propagation value of the pixels adjacent to the active contour in the image, whereby points of the propagating active contour has a binary value;
wherein ii), iii) and iv) are repeated in the selected direction whereby the active contour finally represents the element segmented in the image.

18. The method according to claim 17, further comprising filtering pixels within the propagating active contour to regularize the pixel intensity of elements within the propagating active contour and to regularize a boundary curvature of elements.

19. The method according to claim 18, wherein said filtering pixels is performed periodically between a plurality of sequences of ii), iii) and iv).
